(19) United States
(12) Patent Application Publication
(10) Pub. No.: US 2014/0224689 A1
(43) Pub. Date: Aug. 14, 2014

(54) MOUNTING/DISMOUNTING TOOLKIT FOR DRIVESHAFT AND BEARING OF MOTORCYCLE

(71) Applicant: Hsin-Fa KANG, Tainan (TW)

(72) Inventor: Hsin-Fa KANG, Tainan (TW)

(21) Appl. No.: 13/762,396

(22) Filed: Feb. 8, 2013

(51) Int. Cl. B25H 3/02

(52) U.S. Cl. CPC B25H 3/02
USPC 206/373

(57) ABSTRACT

A mounting/dismounting toolkit for the driveshaft and bearings of a motorcycle essentially includes a box, a driveshaft mounting/dismounting tool set, and a bearing mounting/dismounting tool set. The box has a base and a cover connected by pivotal connectors of the correspondingly lateral sides of the base and the cover. The opposite lateral sides of the base and the cover can be fastened together by a fastener and are each provided with a through hole at corresponding positions. The outer sides of the through holes can jointly form a handle. The base is provided therein with a plurality of chambers respectively shaped to the tools of the driveshaft mounting/dismounting tool set and of the bearing mounting/dismounting tool set. The tools, once received in their respective fixed chambers in the base, are securely positioned in resistance to shaking, are prevented from getting lost, and are conveniently portable.

### BACKGROUND OF THE INVENTION

1. Technical Field

The present invention relates to a mounting/dismounting toolkit for the driveshaft and bearing of a motorcycle, wherein the toolkit includes a toolbox for receiving two tool sets in different uses. Each tool in the two tool sets can be placed in a respective chamber in a base. Once the base is closed and fastened by a cover, the tool is respectively and securely hold in position in the toolbox without shaking By placing each tool in position in the toolbox, the tool is also able to prevent to be misplaced and it is easy to carry.

2. Description of Related Art

Generally, mounting/dismounting tool sets for the driveshaft of a motorcycle gearbox and the bearing of a motorcycle consist of a variety of tools. For example, a driveshaft mounting/dismounting tool set includes a puller, a long sleeve, a short sleeve . . . etc., and a bearing mounting/dismounting tool set includes plural bearing removers in different specifications, plural threaded rods in different lengths, a movable base, a bolt extractor, a pressing block . . . etc. Conventionally, a mounting/dismounting tool set for the driveshaft of a motorcycle gearbox and a mounting/dismounting tool set for the bearing of a motorcycle are sold in such a way that the tools of each tool set are packaged in a plastic bag and then put into a paper box. When using the tools, the packaging materials are thrown away by the buyer after opening, and the tools are usually placed on the ground, a shelf, or a storage bag after using. However, if the tools aren't placed in a constant place, they are easy to be lost because of misplacing. Moreover, if the tools are placed in a storage bag, where the tools are unable to place in position, collision or friction between the tools will cause damage. Additionally, when plural tools are put in the storage bag, the user may have problem seeing all the tools at once, it might take more time on looking for a particular tool or tools and the tools aren't easy to be carried around. Hence, in view of the inconveniences in storing and carrying the foregoing tool sets, the inventor of the present invention conducted extensive research and experiment and finally succeeded in pioneering the subject matter disclosed herein.

### BRIEF SUMMARY OF THE INVENTION

The primary object of the present invention is to provide mounting/dismounting toolkit for the driveshaft and bearing of a motorcycle able to be hold firmly in position in a box without shaking or misplacing so that the toolkit can be carried around conveniently.

According to the present invention, the mounting/dismounting toolkit for the driveshaft and bearing of a motorcycle essentially includes a box, a driveshaft mounting/dismounting tool set, and a bearing mounting/dismounting tool set. The box is composed of a base and a cover. A lateral side of the base and a corresponding lateral side of the cover are connected by a pivotal connector, wherein the pivotal connectors correspond in position to each other. The other lateral side (hereinafter referred to as the fastening lateral side) of the base and the corresponding lateral side (hereinafter referred to as the fastening lateral side) of the cover are able to be fastened. The fastening lateral sides of the base and the cover are each provided with a through hole at corresponding positions, wherein the outer sides of the through holes can jointly form a handle. The base is provided therein with plural chambers for receiving the tools of the driveshaft mounting/dismounting tool set and of the bearing mounting/dismounting tool set respectively. The chambers of the base are respectively shaped according to the tools of the two tool sets. The inner surface of the cover is provided with plural grooves. The driveshaft mounting/dismounting tool set is put in the corresponding chambers in the base and includes a puller, a short sleeve, a long sleeve, and so on. The bearing mounting/dismounting tool set is put in the corresponding chambers in the box and includes plural bearing removers in different specifications, plural pairs of threaded rods in different lengths, a movable base, a bolt remover, a pressing block, and so on.

In the mounting/dismounting toolkit for the driveshaft and bearings of a motorcycle according to the present invention, on the top surface of the base is provided with two positioning projections, and the inner surface of the cover is provided with positioning grooves respectively corresponding in position to the positioning projections.

In the mounting/dismounting toolkit for the driveshaft and bearing of a motorcycle according to the present invention, the puller of the driveshaft mounting/dismounting tool set has one end provided with an inner threaded hole and the other end provided a threaded rod. The threaded rod is disposed with a washer and a nut and has an outer end provided with a holding portion.

In the mounting/dismounting toolkit for the driveshaft and bearing of a motorcycle according to the present invention, the bearing removers are formed in U-shape and each inner lateral side of the bearing removers is provided with an engaging flange. In addition, each bearing remover is provided with two threaded holes corresponding to each other. Two threaded rods are paired while use and can be respectively threaded into the two threaded holes of the bearing removers. The movable base has two opposite lateral sides each provided with a recess. The movable base is also provided with a threaded hole. The bolt remover is threadedly inserted into the threaded hole of the movable base and has one end provided with a grip portion. The pressing block, which is threadedly provided at the other end of the bolt remover, has an end surface provided with a threaded hole and an opposite end surface protrudingly provided with a positioning tip.

### BRIEF DESCRIPTION OF THE SEVERAL VIEWS OF THE DRAWINGS

This invention will be better understood by referring to the accompanying drawings, in which:

FIG. 1 is an exploded perspective view of a box and two tool sets according to an embodiment of the present invention;

FIG. 2 is a perspective view showing how two tool sets placed in a box according to an embodiment of the present invention;

FIG. 3 is a schematic view showing how a driveshaft mounted by means of a driveshaft mounting/dismounting tool set according to an embodiment of the present invention;

FIG. 4 is a schematic view showing how a bearing is dismounted from a driveshaft by means of a bearing mounting/dismounting tool set according to an embodiment of the present invention; and

FIG. 5 is a schematic view showing how a bearing dismounted from a triple clamp by means of a bearing mounting/dismounting tool set according to an embodiment of the present invention.

### DETAILED DESCRIPTION OF THE INVENTION

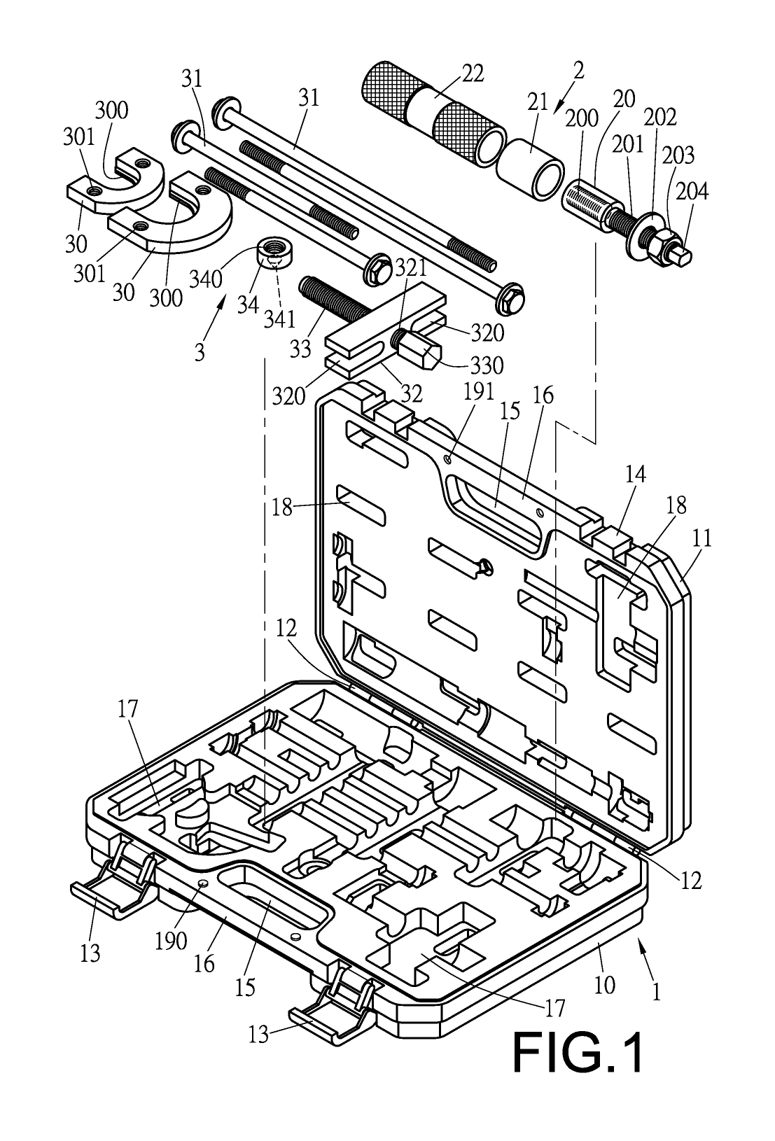

Referring to FIG. 1, a mounting/dismounting toolkit for the driveshaft and bearings of a motorcycle according to an embodiment of the present invention essentially includes a box 1, a driveshaft mounting/dismounting tool set 2, and a bearing mounting/dismounting tool set 3. The box 1 is composed of a base 10 and a cover 11. A lateral side of the base 10 and a corresponding lateral side of the cover 11 are each provided with a pivotal connector 12 and are pivotally connected thereby, wherein the pivotal connectors 12 correspond in position to each other. The opposite lateral side (hereinafter referred to as the fastening lateral side) of the base 10 is provided with a fastener 13, and the corresponding opposite lateral side (hereinafter referred to as the fastening lateral side) of the cover 11 is provided with a fastening portion 14 corresponding in position to the fastener 13. The fastening lateral sides of the base 10 and the cover 11 are each provided with a through hole 15 at corresponding positions. The outer sides of the through holes 15 can jointly form a handle 16. The base 10 is provided therein with a plurality of chambers 17 for receiving the tools of the driveshaft mounting/dismounting tool set 2 and of the bearing mounting/dismounting tool set 3 respectively. The chambers 17 of the base 10 are respectively shaped according to the tools of the two tool sets. The inner surface of the cover 11 is provided with a plurality of grooves 18. The top surface of the base 10 is provided with two positioning projections 190, and the inner surface of the cover 11 is provided with positioning grooves 191 respectively corresponding in position to the positioning projections 190. The driveshaft mounting/dismounting tool set 2 is placed in the corresponding chambers 17 of the base 10. The driveshaft mounting/dismounting tool set 2 includes such tools as a puller 20, a short sleeve 21, and a long sleeve 22. The puller 20 has one end provided with an inner threaded hole 200 and the other end formed as a threaded rod 201. The threaded rod 201 is mounted with a washer 202 and is threadedly provided with a nut 203. The outer end of the threaded rod 201 is provided with a grip portion 204. The bearing mounting/dismounting tool set 3 is placed in the corresponding chambers 17 of the base 10. The bearing mounting/dismounting tool set 3 includes plural bearing removers 30 in different specifications; plural paired threaded rods 31 in different length; a movable base 32; a bolt remover 33; and a pressing block 34. The bearing removers 30 are in U-shape. Each bearing remover 30 has an inner lateral side provided with an engaging flange 300, and threaded holes 301 at corresponding positions. The pair of threaded rods 31 can be respectively threaded into the two threaded holes 301 of the bearing removers 30. The movable base 32 has two opposite lateral sides each provided with a recess 320. The movable base 32 is also provided with a threaded hole 321. The bolt remover 33 is threaded into the threaded hole 321 of the movable base 32. The bolt remover 33 has one end provided with a grip portion 330. The pressing block 34 is threadedly inserted at the other end of the bolt remover 33. One side of the pressing block 34 is disposed with a threaded hole 340 and the other side of the pressing block 34 is protruded as a positioning tip 341.

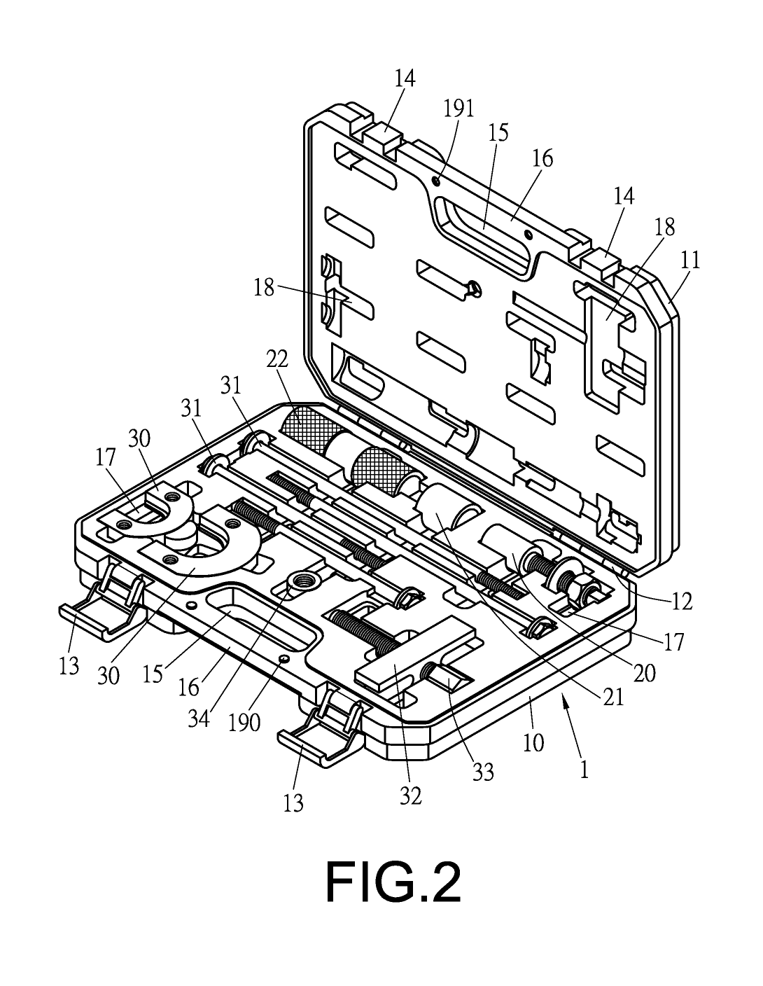

To order to put the tools of the two tool sets in the box 1 for storage, referring to FIG. 1 and FIG. 2, the cover 11 is opened so that the tools of the two tool sets are able to be placed into the corresponding chambers 17 of the base 10 respectively. Thus, the tools are firmly positioned in their respective chambers 17. Afterward, the cover 11 is closed on the base 10, and the fastener 13 of the base 10 is fastened with the fastening portion 14 of the cover 11 to make the cover 11 securely closed on the base 10, and thereby the box 1 can be firmly closed. The tools in the both tool sets placed in the box 1 are securely received in the chambers 17 of the base 10 and are pressed by the inner surface of the cover 11. As a result, the tools are fixedly positioned in the box 1 without shaking so that it can prevent the tools from collision or damage. After using, the tools of the two tool sets can be placed in their respective chambers of the box 1 one after another, thus, the tools won't be easy to be misplaced. To use the tools, the user only has to do is opening the cover 11 and the position of each tool of the two tool sets is clearly in view, allowing the user to easily take out the tool or tools to be used. As the single box 1 serves to receive two sets of tools in different uses, not only is the required storage space reduced, but also the two tool sets can be carried around easily.

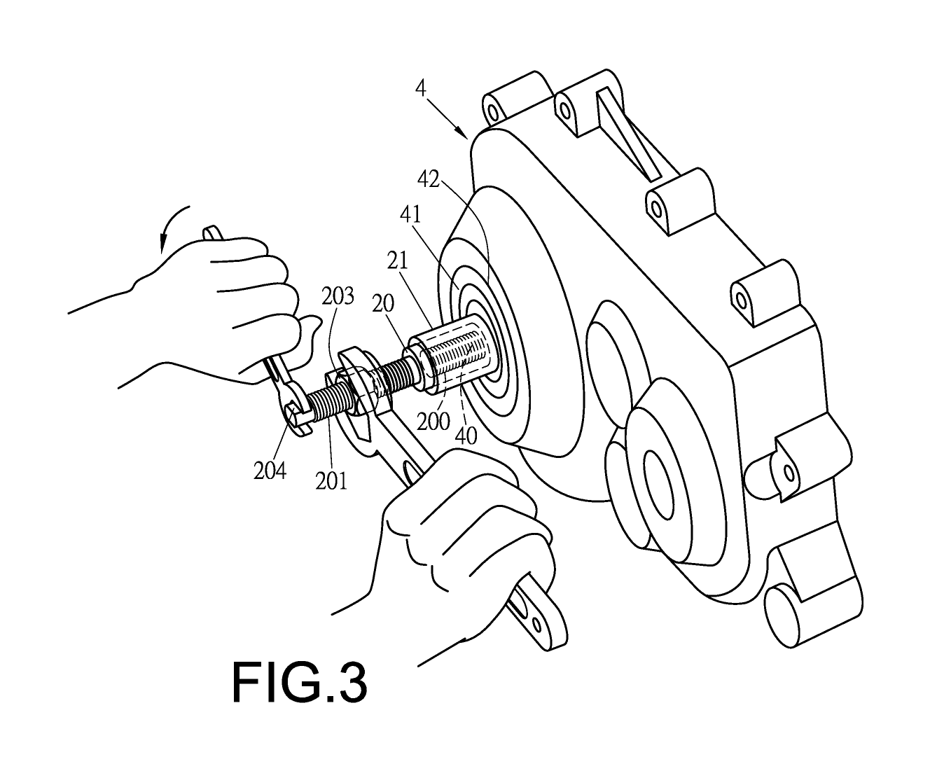

As shown in FIG. 3, when able to mount a driveshaft 40 of a motorcycle gearbox 4, the driveshaft mounting/dismounting tool set 2 is taken out from the box 1, and the applicable one of either the short sleeve 21 or the long sleeve 22 is mounted on the puller 20. The puller 20 is then threadedly connected to the driveshaft 40 of the gearbox 4. The grip portion 204 of the puller 20 is gripped by a wrench 51 while the nut 201 of the puller 20 is gripped securely by another wrench 50. Thus, the puller 20 can be driven to rotate by the wrench 51 gripping the grip portion 204. The puller 20 pulls the driveshaft 40 outward from inside the gearbox 40 until the driveshaft 40 and a bearing 41 are firmly positioned in a shaft hole 42 of the gearbox 4. The above operation can be easily performed.

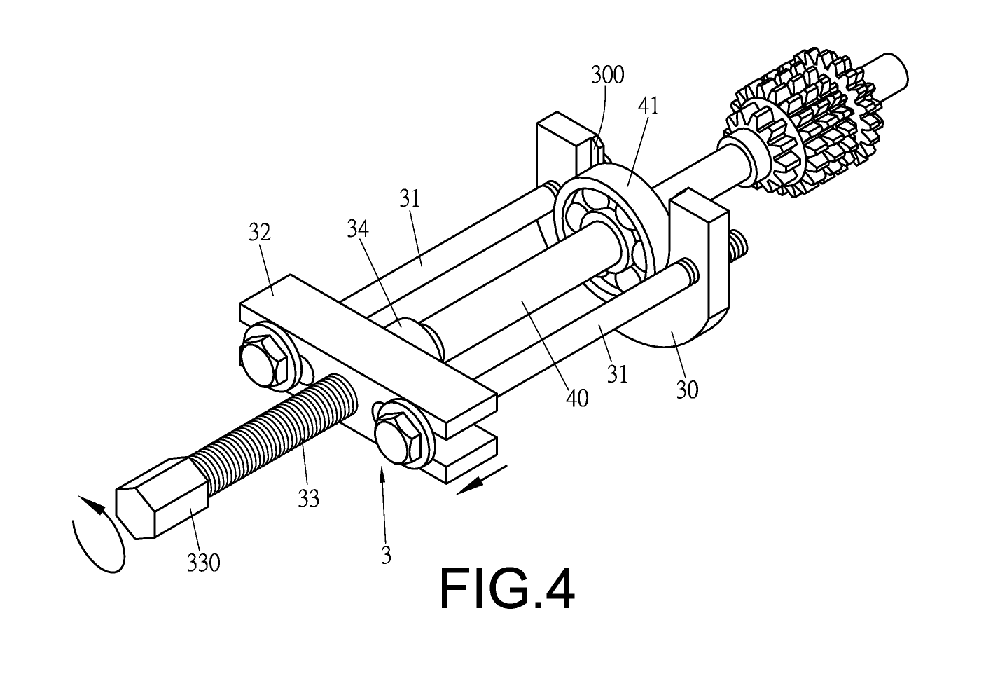

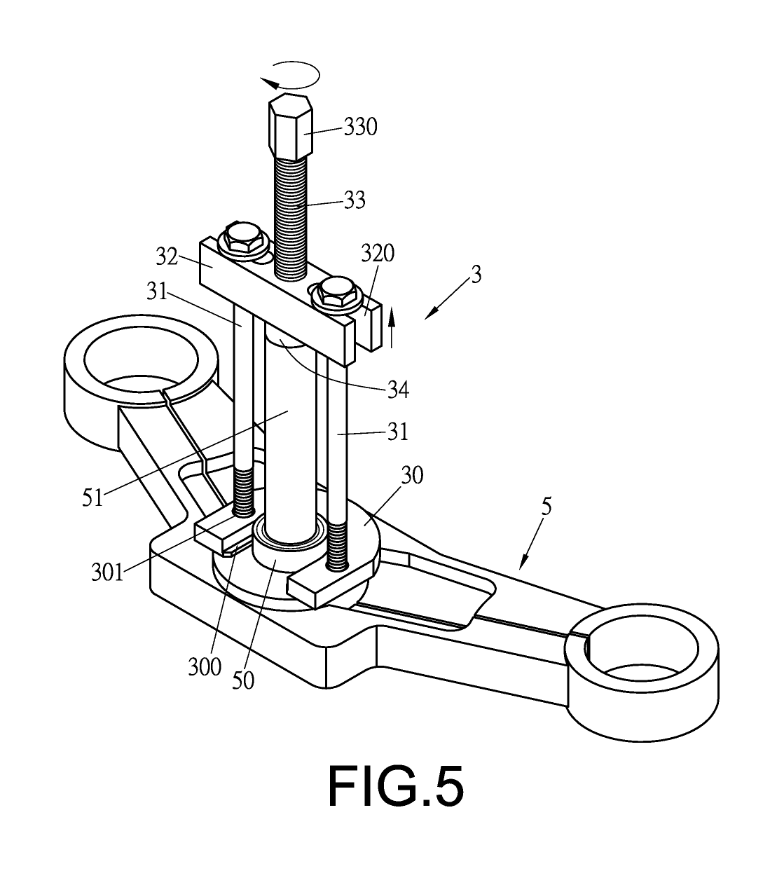

As shown in FIG. 4 and FIG. 5, when able to dismount the bearing 41 of the motorcycle driveshaft 40 or a bearing 50 of a motorcycle triple clamp 5, the bearing mounting/dismounting tool set 3 is taken out from the box 1, and the bearing remover 30 corresponding in size to the bearing 41 of the motorcycle driveshaft 40 or the bearing 50 of the motorcycle triple clamp 5 is selected for use, together with a pair of the threaded rods 31 in appropriate length. The bearing remover 30 is brought into contact with a lateral side of the bearing 41 or 50 such that the engaging flange 300 of the bearing remover 30 engages with a lower edge of the bearing 41 or 50. Then, the two threaded rods 31 are respectively and threadedly provided in the threaded holes 301 of the bearing remover 30, and the movable base 32 is provided at one end of the two threaded rods 31 when the threaded rods 2 are respectively located in the recess 320 on two lateral sides of the movable base 32. The bolt remover 33 is threadedly provided in the threaded hole 321 of the movable base 32. The pressing block 34 is threadedly provided at the second end of the bolt remover 33, wherein the positioning tip 341 of the pressing block 34 is pressed against the exposed end of the motorcycle driveshaft 40 or the exposed end of a shaft 51 of the motorcycle triple clamp 5. Thus, by turning the bolt remover 33, the movable base 32 is moved outward by the bolt remover 33, and the two threaded rods 31 move outward along with the movable base 32, driving the bearing remover 30 to move outward. Consequently, the bearing remover 30, whose engaging flange 300 is engaged with a lateral side of the bearing 41 or 50, pulls out and thereby dismounts the bearing 41 of the motorcycle driveshaft 40 or the bearing 50 of the motorcycle triple clamp 5. The dismounting operation described above can be completed without difficulty.

In conclusion, the present invention not only achieves the anticipated objects and advantages, but is also more satisfactory and practical than the prior art. It should be noted that the foregoing embodiments are only illustrative of the present invention and should not be interpreted as restrictive of the scope of the present invention. All equivalent changes and modifications made to the foregoing embodiments without departing from the technical solution disclosed herein should fall within the scope of the present invention.

What is claimed is:

1. A mounting/dismounting toolkit for a driveshaft and bearings of a motorcycle, comprising a box, a driveshaft mounting/dismounting tool set, and a bearing mounting/dismounting tool set, the box being composed of a base and a cover, wherein a lateral side of the base and a corresponding lateral side of the cover are correspondingly provided with pivotal connectors and are pivotally connected thereby, and wherein an opposite lateral side of the base and a corresponding opposite lateral side of the cover are respectively provided with a fastener and a fastening portion corresponding in position to the fastener and are each provided with a through hole at corresponding positions such that outer sides of the through holes can jointly form a handle, the base being provided therein with a plurality of chambers for respectively receiving tools of the driveshaft mounting/dismounting tool set and tools of the bearing mounting/dismounting tool set, the chambers of the base being respectively shaped according to the tools of the two tool sets, the cover having an inner surface provided with a plurality of grooves, the driveshaft mounting/dismounting tool set being placed in corresponding said chambers of the base, the driveshaft mounting/dismounting tool set comprising a puller, a short sleeve, and a long sleeve, the bearing mounting/dismounting tool set being placed in corresponding said chambers of the base, the bearing mounting/dismounting tool set comprising a plurality of bearing removers in different specifications; a plurality pairs of threaded rods in different length; a movable base; a bolt remover; and a pressing block.

2. The mounting/dismounting toolkit of claim 1, wherein the base of the box has a top surface provided with two positioning projections, and the inner surface of the cover of the box is provided with positioning grooves respectively corresponding in position to the positioning projections of the base.

3. The mounting/dismounting toolkit of claim 1, wherein the puller of the driveshaft mounting/dismounting tool set has an end provided with an inner threaded hole and an opposite end formed as a threaded rod being mounted with a washer and threadedly provided with a nut, and having an outer end provided with a grip portion.

4. The mounting/dismounting toolkit of claim 1, wherein the bearing removers of the bearing mounting/dismounting tool set are in U-shape, each have an inner lateral side provided with an engaging flange, and are each provided with two threaded holes at corresponding positions; each said pair of threaded rods consists of two said threaded rods and can be respectively and threadedly provided in the two threaded holes of any said bearing remover; the movable base has two opposite lateral sides each provided with a recess, and the movable base is provided with a threaded hole; the bolt remover is threadedly provided in the threaded hole of the movable base and has an end provided with a grip portion; and the pressing block is threadedly provided at an opposite end of the bolt remover and has an end surface provided with a threaded hole and an opposite end surface protrudingly provided with a positioning tip.
